(19) United States
(12) Patent Application Publication
(10) Pub. No.: US 2026/0286056 A1
(43) Pub. Date: Sep. 24, 2026

(54) POLYMERISATION OF SILOXANE POLYMERS

(71) Applicants: Dow Global Technologies LLC, Midland, MI (US); Dow Silicones Corporation, Midland, MI (US)

(72) Inventors: John Roberts, Midland, MI (US); Michael Molnar, Freeland, MI (US)

(21) Appl. No.: 19/475,552

(22) PCT Filed: May 20, 2024
(86) PCT No.: PCT/US2024/030189

§ 371 Date: Oct. 15, 2025

Related U.S. Application Data
(60) Provisional application No. 63/468,859, filed on May 25, 2023.

(51) Int. Cl. C08G 77/10; C08G 77/08

(52) U.S. Cl. CPC C08G 77/10; C08G 77/08

(57) ABSTRACT

This relates to a process for the preparation of siloxane polymers and copolymers, made by acid (cationic) catalysed ring-opening polymerisation of macrocyclic cyclosiloxane oligomers having from seven to ten siloxane units per macrocyclic cyclosiloxane oligomers. It also relates to the siloxane polymers and copolymers, made by the process and their uses.

This relates to a process for the preparation of siloxane polymers and copolymers, made by acid (cationic) catalysed ring-opening polymerisation of macrocyclic cyclosiloxane oligomers. It also relates to the siloxane polymers and copolymers, made by the process and their uses.

Cyclosiloxane oligomers are formed by the hydrolysis of diorganodichlorosilanes and can be isolated by distillation. They are critical intermediates in the silicone industry as they are used as one of the main building blocks in the preparation of siloxane polymers and copolymers.

Each siloxane unit in a cyclosiloxane oligomer is typically of the structure:

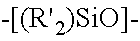

with each R′ group being the same or different and usually, but not exclusively, an alkyl group or an aryl group. Hence said cyclosiloxane oligomers may, for example, comprise dimethyl siloxane units, methylethyl siloxane units and/or phenylmethyl siloxane units in the ring.

The cyclosiloxane oligomers used as polymer building blocks typically have an average of from 3 to 5 siloxane units in each cyclosiloxane ring. Usually, but not always, the cyclosiloxane oligomers have an average of about 4 siloxane units in each cyclosiloxane ring because octamethylcyclotetrasiloxane is probably one of the most abundant cyclosiloxane feedstocks and is often found to be the purest of the distilled cyclosiloxanes. That said, examples of such cyclosiloxane oligomers having 3 to 5 siloxane units per molecule include in addition to octamethylcyclotetrasiloxane, hexamethylcyclotrisiloxane, decamethylcyclopentasiloxane, cyclotetra(phenylmethyl)siloxane and mixtures thereof. However, octamethylcyclotetrasiloxane is essentially the only cyclosiloxane used in homogeneous acid-catalyzed ring opening polymerization.

Typically, cyclosiloxane oligomers and mixtures thereof, undergo a polymerisation process involving the ring opening of the cyclosiloxane oligomers in the presence of acid or base catalysts optionally with suitably end-blocked linear/branched polydiorganosiloxanes (end-blockers). An equilibrium between the desired siloxane polymers and a mixture of cyclosiloxane compounds is created in the course of the polymerisation reaction. The resulting equilibrium largely depends on the nature and number of cyclosiloxane compound(s), the catalyst used and the polymerisation process temperature. When utilising octamethylcyclotetrasiloxane as the starting material it also tends to be the prevalent cyclosiloxane as a result of the equilibration.

Given the basic or acidic nature of the catalysts used, such polymerisation processes are generally terminated or quenched by the addition of a neutralizing agent designed to react with the chosen acid or base catalyst to render it non-active. Where possible, catalyst residues are preferably removed from the resulting polymer product by an appropriate separation method, e.g., filtration.

Base catalysts which have been utilised include, but are not limited to, alkali metal hydroxides such as potassium or caesium hydroxide, alkali metal alkoxides or complexes of alkali metal hydroxides and an alcohol, alkali metal silanolates such as potassium silanolates or trimethylpotassium silanolate phosphazene bases and the catalyst derived by the reaction of a tetra-alkyl ammonium hydroxide and a siloxane tetramer as described in U.S. Pat. No. 3,433,765.

However, in certain situations the use of base catalysis is not preferred, e.g., base catalysts tend to degrade polymers containing Si—H groups. In such cases acid catalysts are typically used for making polymers with Si—H functionality. They also tend to be used in the preparation of lower viscosity and commodity (trimethyl endcapped) polymers. Typically, octamethylcyclotetrasiloxane is essentially the only cyclosiloxane used in homogeneous acid-catalyzed ring opening polymerization (vs acid clays used in condensation/equilibration polymerization). Acid catalysts which have been used include perfluorinated sulfonic acids such as triflic acid (trifluoromethane sulphonic acid) and perfluorobutane sulfonic acid, etc.; sulfated polystyrene resins (such as AMBERLYST™-15 a Brønsted acidic resin catalyst.), NAFTON™ resins, commercially available from The Chemours Company of Wilmington, Delaware, USA and phosphonitrile halides (sometimes referred to as acidic phosphazenes).

Although many of these catalysts are highly active, they tend to produce large quantities (>1000 ppm) of the cyclic by-products, most often octamethylcyclotetrasiloxane, through the equilibrium reaction.

There is a desire in the industry to reduce the reliance on cyclosiloxane oligomers having an average of about 4 siloxane units in processes for the preparation of siloxane polymers from cyclosiloxane ring starting ingredients through equilibrium reactions.

There is provided herein an acid catalysed process for the preparation of linear or branched siloxane polymers and copolymers, by the ring-opening polymerisation of macrocyclic cyclosiloxane oligomers having from 7 to 10

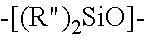

units per molecule, wherein each R″ group per unit is the same or different and is an alkyl group having from 1 to 6 carbons; which acid catalysed process comprises the steps of
(a) introducing
   (i) said macrocyclic cyclosiloxane oligomers in an amount of from 20 to 99 wt. % of the starting ingredients with
   (ii) one or more end-blockers in an amount of from 1 to 80 wt. % of the starting ingredients and optionally
   (iii) a co-monomer selected from a linear organosiloxane co-monomer, a branched organosiloxane co-monomer or a cyclosiloxane co-monomer wherein said cyclosiloxane co-monomer has from 3 to 10

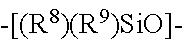

units per molecule, wherein each R⁸ group per is the same or different and is selected from an alkenyl group, an alkynyl group, an aryl group, a fluoroalkyl such as trifluoropropyl or a perfluoroalkyl group and each R⁹ group is selected from an alkyl group having from 1 to 6 carbons or R⁸; in an amount of from 1 to 80 wt. % of the starting ingredients into a mixing vessel and mixing;
(b) optionally introducing an organic solvent in an amount of up to 30 wt. % of the starting ingredients into the mixing vessel during or subsequent to step (a);
(c) heating said mixture of starting ingredients to a predetermined reaction temperature of from 25 to 160° C. in an inert atmosphere;
(d) once the predetermined reaction temperature has been reached, introducing a final starting ingredient, an acid catalyst (iv) selected from one or more sulphonic acids and/or perfluorinated sulfonic acids, one or more sulfonated polystyrene resins,
   one or more sulfonated tetrafluoroethylene bases fluoropolymer-copolymer resins or a mixture thereof, in an amount of from 0.001 wt. % to 10 wt. % of the starting ingredients; thereby forming a complete reaction mixture;
(e) reacting the complete reaction mixture of step (d) at the predetermined reaction temperature for up to 24 hours until a step (e) product within a desired number average molecular weight range and/or a cyclics equilibration is obtained;
(f) quenching the reaction after step (e) by either filtering off heterogeneous acid catalysts when used or with a suitable neutralising agent to form a step (f) product;
(g) Cooling the step (f) product to ambient temperature to form a step (g) product and optionally,
(h) Stripping out remaining volatile materials from the step (g) product;
   to give a final linear or branched siloxane polymer or copolymer.

The total amount of the complete reaction mixture resulting in step (d) is 100 wt. % of the starting ingredients.

There is also provided a use of an acid catalyst in the preparation of linear or branched siloxane polymers and copolymers, by the ring-opening polymerisation of macrocyclic cyclosiloxane oligomers having from 7 to 10

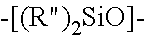

units per molecule, wherein each R″ group per unit is the same or different and is an alkyl group having from 1 to 6 carbons in accordance with the process described herein.

There is also provided a linear or branched siloxane polymers and copolymer obtained or obtainable from the process described herein.

### Macrocyclic Cyclosiloxane Oligomer Starting Materials (i)

The macrocyclic cyclosiloxane oligomer starting materials (i) are deemed to be “macrocyclic” because they have at least seven, specifically here, from 7 to 10 siloxane units of the structure:

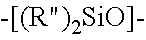

per cyclosiloxane oligomer as opposed to the standard four or five. However, each R″ group per unit is the same or different and is an alkyl group having from 1 to 6 carbons. Hence said cyclosiloxane oligomers may, for example, comprise dimethylsiloxane units, methylethyl siloxane units, diethylsiloxane units, methylpropyl siloxane units, dipropylsiloxane units and/or or tertiary butylmethyl siloxane units (tertiary butyl is hereafter referred to as ^{t}butyl). In one embodiment all the siloxane units in each molecule are the same. In another embodiment at least one R″ group per unit is a methyl or ethyl group, alternatively a methyl group. Hence, the macrocyclic cyclosiloxane oligomer starting materials (i) may comprise, for the sake of example oligomers of the structure [(CH₃)₂)SiO]_{n″}, [(C₂H₅)₂)SiO]_{n″}, [(C₃H₇)₂)SiO]_{n″}, [(CH₃)(C₂H₅)SiO]_{n″}, and/or [(CH₃)(C₃H₇)SiO]_{n″} where n″ is from 7 to 10. Specific examples of such macrocyclic cyclosiloxane oligomers include but are not limited to:
tetradecamethylcycloheptasiloxane ([(CH₃)₂)SiO]₇),
hexadecamethylcyclooctasiloxane ([(CH₃)₂)SiO]s),
octadecamethylcyclononasiloxane ([(CH₃)₂)SiO]₉),
icosamethylcyclodecasiloxane ([(CH₃)₂)SiO]₁₀),
tetradecaethylcycloheptasiloxane ([(C₂H₅)₂)SiO]₇),
hexadecaethylcyclooctasiloxane ([(C₂H₅)₂)SiO]s),
octadecaethyllcyclononasiloxane ([(C₂H₅)₂)SiO]₉),
icosaethylcyclodecasiloxane ([(C₂H₅)₂)SiO]₁₀),
tetradecapropylcycloheptasiloxane ([(C₃H₇)₂)SiO]₇),
hexadecapropylcyclooctasiloxane ([(C₃H₇)₂)SiO]₈),
octadecapropylcyclononasiloxane ([(C₃H₇)₂)SiO]₉),
icosapropylcyclodecasiloxane ([(C₃H₇)₂)SiO]₁₀),
cyclohepta(methylethyl)siloxane ([(CH₃)(C₂H₅)SiO]₇),
cycloocta(methylethyl)siloxane ([(CH₃)(C₂H₅)SiO]₈),
cyclonona(methylethyl)siloxane ([(CH₃)(C₂H₅)SiO]₉),
cyclodeca(methylethyl)siloxane ([(CH₃)(C₂H₅)SiO]₁₀),
cyclohepta(methylpropyl)siloxane ([(CH₃)(C₃H₇)SiO]₇),
cycloocta(methylpropyl)siloxane ([(CH₃)(C₃H₇)SiO]₈),
cyclonona(methylpropyl)siloxane ([(CH₃)(C₃H₇)SiO]₉) or
cyclodeca(methylpropyl)siloxane ([(CH₃)(C₃H₇)SiO]₁₀),
and mixtures thereof.

Of the above, rings having seven siloxane units are preferred e.g., tetradecamethylcycloheptasiloxane, tetradecaethylcycloheptasiloxane, tetradecapropylcycloheptasiloxane, cyclohepta(methylethyl)siloxane, cyclohepta(methylpropyl)siloxane and mixtures thereof. The macrocyclic cyclosiloxane oligomer starting materials are present in the starting composition in an amount of from 20 to 99 wt. % of the starting ingredients, alternatively in an amount of from 50 to 99 wt. % of the starting ingredients, alternatively in an amount of from 70 to 99 wt. % of the starting ingredients, alternatively in an amount of from 80 to 99 wt. % of the starting ingredients, alternatively in an amount of from 85 to 99 wt. % of the starting ingredients.

### End-Blockers (ii)

The one or more end-blockers (ii) are present in an amount of from 1 to 80 wt. % of the starting ingredients, alternatively in an amount of from 1 to 50 wt. % of the starting ingredients, alternatively in an amount of from 1 to 30 wt. % of the starting ingredients, alternatively in an amount of from 1 to 20 wt. % of the starting ingredients, alternatively in an amount of from 1 to 15 wt. % of the starting ingredients.

They are used in order to regulate the molecular weight of the polymer and/or to add terminal functionality. End-blocking agents (i.e., end-blockers) are a means of controlling the reactivity/polymer chain length of the polymer and as a means of introducing functionality to the resulting polymer. The end-blocking agent (end-blocker) halts the polymerization reaction and thereby limits the average molecular weight of the resulting polymer. Any suitable end-blocking agent (end-blocker) known to those skilled in the art may be used and typically will be chosen with the end use of the polymer in mind.

Suitable end-blocking agents (end-blockers) include functionally terminated polysiloxanes having a degree of polymerisation of from 2 to 2500, for example, functionally terminated short chain (e.g., from a degree of polymerisation of from 2 to 30 silicon atoms) polysiloxanes or disiloxanes such as alkenyl dialkyl-terminated polydimethylsiloxanes and polydimethylsiloxanes having terminal groups containing Si—H bonds; polydimethylsiloxanes (having from 2 to 2000 silicon atoms in the polymer backbone) dialkylsilanol-terminated or dialkylalkenyl-terminated, e.g., dialkylvinyl-terminated or dialkylhexenyl-terminated. They may also include trialkyl-terminated polydimethylsiloxanes as well as mixtures of any of the above. Other potential end-blockers include silanes, e.g., alkoxy functional silanes and silanols such as trimethyl silanol, trimethylmethoxysilane, and/or methyltrimethoxysilane. Water also acts as an end-blocker, with the introduction of hydroxy functional groups. Specific suitable end-blockers for the present process include, but are not limited to, dimethylalkenyl-terminated polydimethylsiloxanes having a degree of polymerisation of from 10 to 350 such as dimethyl vinyl-terminated polydimethylsiloxanes having a degree of polymerisation of from 10 to 100 and dimethylhexenyl-terminated polydimethylsiloxanes having a degree of polymerisation of from 100 to 350, as well as trialkyl-terminated polydimethylsiloxanes, usually trimethyl-terminated polydimethylsiloxanes having a viscosity of from 15 to 200 mPa·s at 25° C. such as XIAMETER™ PMX-200 Silicone Fluid 20 cSt, a trimethyl-terminated polydimethylsiloxane having a viscosity of 20 cSt at 25° C., commercially available from Dow Silicones Corporation of Midland, Michigan USA. The end-blockers may also comprise one or more disiloxanes such as hexamethyldisiloxane, 1,1,3,3-tetramethyldisiloxane, and 1,3-divinyltetramethyldisiloxane. Any suitable method to measure viscosity may be utilised for example viscosity may be measured using a Brookfield cone and plate Viscometer such as a Brookfield LVDV-E viscometer.

Co-Monomers (iii)

Co-monomers (iii) are optionally present. When present a co-monomer may be selected from a linear organopolysiloxane co-monomer, a branched organopolysiloxane co-monomer or a cyclosiloxane co-monomer, wherein said cyclosiloxane co-monomer has from 3 to 10

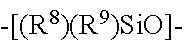

units per molecule, wherein each R⁸ group per is the same or different and is selected from an alkenyl group, an alkynyl group, an aryl group, a fluoroalkyl such as trifluoropropyl or a perfluoroalkyl group and each R⁹ group is selected from an alkyl group having from 1 to 6 carbons or R⁸.

Co-monomer (iii) may comprise or consist of a linear or branched organopolysiloxane comprising units of the structure:

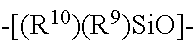

units per molecule, wherein each R¹⁰ group per is the same or different and is selected from an alkenyl group, an alkynyl group, an aryl group, a fluoroalkyl such as trifluoropropyl or a perfluoroalkyl group or a primary or secondary amine groups or alkylethylenediamine groups and each R⁹ group is selected from an alkyl group having from 1 to 6 carbons or R¹⁰.

The linear organopolysiloxane co-monomer and branched organopolysiloxane co-monomer may comprise dialkylsilanol-terminated polydiorganosiloxanes having alkenyl containing and/or amine containing side chains. The alkenyl containing side chains may contain from 2 to 10 carbons, e.g., vinyl groups, propenyl groups, n-butenyl groups, n-pentenyl groups and n-hexenyl groups. The amine containing side chains may comprise primary or secondary amines or alkylethylenediamine groups wherein the alkyls have 2 to 10 carbons, alternatively, 2 to 7 carbons, alternatively 3 to 6 carbons, such as, for the sake of example groups such as —(CH₂)₃NH(CH₂)₂NH₂, —(CH₂)₂NH(CH₂)₂NH₂, —CH₂CH(CH₃)CH₂NH(CH₂)₂NH₂ and —(CH₂)₄NH(CH₂)₂NH₂ or mixtures thereof.

The cyclic co-monomers may include for the sake of example methylvinylsiloxane units, trifluoroalkylmethylsiloxane units, e.g., trifluoropropylmethylsiloxane units and/or phenylmethylsiloxane units in the ring. The cyclic co-monomers may for example include but are not limited to one or more of the following:

[(CH₃)(CH═CH₂)SiO]_{n′}, (CH₃)((CH₂)₄ CH═CH₂)SiO]_{n′}, [(CH₃)(Ph)SiO]_{n′}, (where Ph=phenyl), ([(Ph)₂SiO]_{n′}, [(CF₃(CH₂)₂)(CH₃)SiO]_{n′}, and cyclic aminosiloxanes such as (CH₃)(NH₂)SiO]_{n′}, and/or [(CH₃)(—(CH₂)₃NH(CH₂)₂NH₂)SiO]_{n′}; where n′ is from 3 to 10, alternatively from 4 to 8, and mixtures comprising at least one of the above.

Of the above ring structures, cyclic siloxanes having seven siloxane units as described might include e.g., tetradecamethylcycloheptasiloxane, cyclohepta(methylvinyl)siloxane, cyclohepta(phenylmethyl)siloxane, cyclohepta(methylhydro)siloxane and cyclohepta(trifluoropropylmethyl)siloxane. However, the number of siloxane groups in cyclic co-monomers is not overly important but in one embodiment the cyclic siloxane co-monomers are macrocyclic cyclosiloxane oligomers.

Alternatively, or additionally, when present, co-monomer (iii) may comprise or consist of a trialkyl-silyl-terminated linear or a trialkyl silyl-terminated branched organopolysiloxane. The trialkyl silyl-terminated linear or a trialkyl silyl-terminated branched organopolysiloxane may comprise multiple units of the structure:

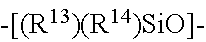

units per molecule, wherein each R¹³ group per siloxane unit is the same or different and is selected from an alkenyl group, an alkynyl group, an aryl group, a fluoroalkyl such as trifluoropropyl or a perfluoroalkyl group or a primary or secondary amine groups or alkylethylenediamine groups and each R¹⁴ group is selected from an alkyl group having from 1 to 6 carbons or R¹³.

The linear organopolysiloxane co-monomer and branched organopolysiloxane co-monomer may comprise dialkylsilanol-terminated polydiorganosiloxanes having alkenyl containing and/or amine containing side chains. The alkenyl containing side chains may contain from 2 to 10 carbons, e.g., vinyl groups, propenyl groups, n-butenyl groups, n-pentenyl groups and n-hexenyl groups. The amine containing side chains may comprise primary or secondary amines or alkyl ethylenediamine groups wherein the alkyls have 2 to 10 carbons, alternatively, 2 to 7 carbons, alternatively 3 to 6 carbons, such as, for the sake of example groups such as —(CH₂)₃NH(CH₂)₂NH₂, —(CH₂)₂NH(CH₂)₂NH₂, —CH₂CH(CH₃)CH₂NH(CH₂)₂NH₂ and —(CH₂)₄NH(CH₂)₂NH₂ or mixtures thereof.

Surprisingly, it was found that co-monomers can be easily incorporated at relatively low levels (<10 wt. %) under the milder reaction conditions for which the tetradecamethylcycloheptasiloxane polymerization proceeds. Both cyclosiloxane and hydrolysate co-monomer sources were proved to work, even at significantly lower temperatures anywhere between 25° C. to 160° C., e.g., 50° C. to 125° C. than the reaction temperature used for octamethylcyclosiloxane process (160° C. or even more).

Co-monomers (iii) can be incorporated into the mixture in several ways. For example, they can be equilibrated in from homopolymers of the co-monomer or added as reactive monomers. Hydrolysate co-monomers may be functional cyclosiloxane cyclics hydrolysate (a mixture of cyclosiloxanes and silanol-terminated homopolymer), or a functional homopolymer.

When present co-monomer (iii) is present in an amount of from 1 to 80 wt. % of the starting ingredients alternatively in an amount of from 1 to 50 wt. % of the starting ingredients, alternatively in an amount of from 1 to 25 wt. % of the starting ingredients, alternatively in an amount of from 1 to 15 wt. % of the starting ingredients, alternatively in an amount of from 1 to 10 wt. % of the starting ingredients.

### Organic Solvent

In optional step (b) which involves introducing an organic solvent in an amount of up to 7.5 wt. % of the starting ingredients into the mixing vessel during or subsequent to step (a), the organic solvent concerned is typically an organic solvent such as a linear, branched or cyclic aliphatic hydrocarbon which may optionally be chlorinated; linear, branched or cyclic ethers or aromatic solvents. For example, the organic solvents may be aprotic solvents, such as tetrahydrofuran, toluene, or dichloromethane. The organic solvent, when present, is different from the cyclic oligomer, end-blocker and co-monomer starting ingredients described above.

When present the organic solvent, may be used to deliver one or more of the other starting materials. For example, a starting material may be dissolved in an organic solvent before combining with the other ingredients. The organic solvent may be used to deliver one or more starting materials and the reaction may proceed in organic solvent, or both. The amount of organic solvent depends on various factors including the type and amount of the other starting materials selected and on whether one or more starting materials is/are being delivered in an organic solvent, or whether the reaction will proceed in an organic solvent. However, preferably no organic solvent is introduced into the mixing vessel during or subsequent to step (a) and as such the process has then been undertaken “neat”.

### Catalyst (iv)

Once the predetermined reaction temperature has been reached at the end of step (c), in step (d), a final starting ingredient, an acid catalyst, is introduced into the composition to form the complete reaction mixture. The catalyst is an acid catalyst selected from one or more sulphonic acids such as dodecylbenzene sulphonic acid, a perfluorinated sulfonic acids such as trifluoromethanesulfonic acid (also known as triflic acid), perfluorobutane sulfonic acid, e.g., nonafluorobutane-1-sulfonic acid, a carborane acid, a phosphonitrile halides (sometimes referred to as acidic phosphazenes) one or more sulfonated polystyrene resins, such as Amberlyst™-15, a Brønsted acidic resin catalyst commercially available from DuPont de Nemours, Inc. of Wilmington, Delaware, USA and Dowex™ 2030 monosphere commercially available from The Dow Chemical Company of Midland Michigan, USA; one or more sulfonated tetrafluoroethylene bases fluoropolymer-copolymers sold under the Nafion™ tradename by the Chemours company of Wilmington, Delaware, USA a mixture thereof, in an amount of from 0.001 wt. % to 10 wt. % of the starting ingredients, alternatively 0.01 wt. % to 5 wt. %.

In the process described herein, macrocyclic cyclosiloxane oligomers (i) and co-monomer(s) (iii) when present are preferably, introduced into the mixing vessel dry. They may be dried by any suitable process, such as, for example, drying over molecular sieves or the like or by distillation and nitrogen stripping.

The mixing vessel may be any suitable type of mixing vessel but is preferably a batch mixer. Historically, the ring opening polymerisation of oligomers having four siloxane units per ring (e.g., octamethylcyclotetrasiloxane) is undertaken at a temperature of at least 160° C. In step (c) of the process herein, however, whilst the mixing vessel, e.g., batch reactor or continuous plug-flow type reactor may be heated to a predetermined reaction temperature as high as 160° C. if desired, this would appear unnecessary unless specifically desired to complete the reaction exceptionally quickly and preferably the predetermined reaction temperature for the acid catalysed ring-opening polymerisation of macrocyclic cyclosiloxane oligomers described herein can be from greater than (>) 25° C. to 160° C. but advantageously can be from >25° C. to 150° C., alternatively from >25° C. to 125° C., alternatively from >25° C. to 100° C. alternatively from 40° C. to 100° C. alternatively from 50° C. to 100° C. as the resulting ring-opening polymerisation process benefits from undertaking polymerisation at much lower temperatures if desired. The reaction is undertaken in an inert atmosphere, i.e., under nitrogen and/or argon, alternatively under nitrogen.

Once the initial reaction mixture has reached the predetermined reaction temperature in step (c) catalyst (iv) is added to form the complete reaction mixture in step (d). Subsequent to the addition of catalyst (iv) the ring-opening polymerisation reaction takes place in step (e). The contents of the reaction vessel in step (e) are agitated in any suitable way e.g., by stirring the contents of the reaction vessel or by shaking or sonicating or the like the reaction vessel itself throughout the reaction process step (e) for up to 24 hours.

### Neutralising Agent

Any suitable neutralising agent may be used in step (f) to quench the reaction after step (e) and to form a step (f) product. This may include, for the sake of example, pyridine, one or more amine bases, a basic carbonate such as calcium carbonate or a bicarbonate. Neutralisation takes place after a certain reaction period or when the reaction product has reached a desired number average molecular weight (Mn) or weight average molecular weight (Mw) has been achieved determined by size exclusion chromatography using the method described in the examples, for example when Mn has reached a value of from 5000 Da to 100000 Da. Alternatively neutralisation may take when a pre-determined equilibrium has been reached.

Once the reaction has been quenched in said step (f), the reaction mixture is cooled to ambient temperature in step (g) to form a step (g) product which is the final linear or branched siloxane polymer or copolymer and which is then typically removed from the reaction vessel e.g., batch reactor and collected or undergoes optionally stripping step (h) to remove remaining volatile materials from the step (g) product to give the final linear or branched siloxane polymer or copolymer.

Optional step (h) stripping of the step (g) product may be undertaken using any suitable means, for example using a wiped film evaporator sometimes referred to as a “WFE”. The WFE is designed to continuously strip out volatile compounds by mechanically vibrating a thin film, in this case, the final linear or branched siloxane polymer or copolymer on a heated surface at a temperature, in a range of from 20° C. to 210° C. Alternatively, optional step (h) may be undertaken using an aluminum pan with a heating element placed over it, again at a temperature, in this case, in a range of from 20° C. to 210° C.

If desired the resulting final linear or branched siloxane polymer or copolymer maybe evaluated for molecular weight, cyclosiloxane content, cyclosiloxane makeup, and optionally non-volatile content subsequent to completion of the process.

### Final Linear or Branched Siloxane Polymer or Copolymer

The process described herein produces a final linear or branched siloxane polymer or copolymer, which can be of any appropriate molecular weight and/or degree of polymerisation. For example, the number average molecular weight (Mn) or weight average molecular weight (Mw), determined by size exclusion chromatography using the method described in the examples, may be at least 2500 Da, alternatively at least 5000 Da i.e., in a range of from 5000 Da to 100,000 Da, alternatively when Mn has reached a value of from 5000 Da to 30,000 Da. Typically, the degree of polymerisation of the final linear or branched siloxane polymer or copolymer, produced via the process herein may be of any desired suitable chain length. It may be as short as 10 but is typically greater than (>) 50, alternatively>100, alternatively>300, alternatively>400, alternatively>500, alternatively>1000, alternatively>1500, and alternatively>2000. Typically, the degree of polymerisation of the polymers produced via the process herein is greater than 10, alternatively greater than 100, alternatively greater than 300 alternatively greater than 500, alternatively greater than then 1000.

Furthermore, advantageously the resulting product has a low cyclosiloxane, particularly octamethylcyclotetrasiloxane and decamethylcyclopentasiloxane, content e.g., less than (<) 10 wt. % (100,000 ppm), alternatively<8 wt. % (80,000 ppm), alternatively<7 wt. % (70,000 ppm).

As previously indicated the cyclosiloxane oligomers used as polymer building blocks typically have an average of from 3 to 5 siloxane units in each cyclosiloxane ring. Usually, but not always, the cyclosiloxane oligomers have an average of about 4 siloxane units (i.e., octamethylcyclotetrasiloxane) in each cyclosiloxane ring. This is typically because siloxane rings having four siloxane units, especially octamethylcyclotetrasiloxane are probably the most abundant cyclosiloxane feedstock and is often found to be the purest of the distilled cyclosiloxanes.

Moreover, octamethylcyclotetrasiloxane is substantially the only cyclosiloxane used in homogeneous acid-catalyzed ring opening polymerization. Surprisingly, however, it has now been determined that macrocyclic cyclosiloxane oligomer starting materials (i) as described herein, especially those having seven siloxane units per ring (e.g., tetradecamethylcycloheptasiloxane) may be polymerized using acid catalysis as described herein, at a faster rate than cyclosiloxane oligomers having an average of 3 to 5 siloxane units, particularly octamethylcyclotetrasiloxane, under the same reaction conditions. Consequently, the macrocyclic cyclosiloxane oligomer starting materials (i) as described herein, can undergo polymerisation under milder conditions than are standard for cyclosiloxane oligomers having an average of from 3 to 5 siloxane units in each cyclosiloxane ring even when incorporating one or more end-blockers and optionally co-monomers. Even with large amounts of co-monomers (iii) present in the complete reaction mixture it was found that polymers were easily prepared in the presence of macrocyclic cyclosiloxane oligomer starting materials (i) especially those having seven siloxane units per ring (e.g., tetradecamethylcycloheptasiloxane).

This was considered quite surprising as it was anticipated that the resulting polymers would be likely to polymerise into a dimethylsiloxane homopolymer form and fail to incorporate components (ii) and (iii) into the polymer produced.

Furthermore, if desired, resulting final linear or branched siloxane polymer or copolymers produced by the process herein may contain pendant functionality as a result of acid catalysis with such enhanced kinetics. Unexpectedly, it has been identified that macrocyclic cyclosiloxane oligomer starting materials (i) having seven siloxane units (e.g., tetradecamethylcycloheptasiloxane) seem to be the most efficiently polymerised, contrary to initial expectations, anticipating the reaction kinetics increasing with increasing ring size of the macrocyclic cyclosiloxanes. Indeed, it was found that the that macrocyclic cyclosiloxane oligomer starting materials (i) having seven siloxane units polymerized under acid catalysis with enhanced kinetics can incorporate pendant functionality via an equilibration reaction pathway with hydrolysate co-monomers. Furthermore, that macrocyclic cyclosiloxane oligomer starting materials (i) having seven siloxane units (e.g., tetradecamethylcycloheptasiloxane) can be polymerized using a heterogeneous catalyst.

Ring opening polymerisation (ROP) of these siloxanes proceeds via an equilibration polymerisation reaction pathway which results in polymer preparation in conjunction with the production of cyclic oligomer equilibrium by-products (especially octamethylcyclotetrasiloxane. However, it has unexpectedly been identified that the acid catalysed polymerisation process described herein produces much lower levels of the cyclic oligomers such as octamethylcyclotetrasiloxane as by-products of the equilibration polymerisation process. It was also determined that using that macrocyclic cyclosiloxane oligomers having seven siloxane units as component (i) was preferred to using macrocyclic cyclosiloxane oligomers having eight siloxane units, nine siloxane units and ten siloxane units per ring as they produced less cyclic by-products during the polymerisation process described herein.

Whilst it is advantageous to use said macrocyclic cyclosiloxane oligomers as component (i) because they have been identified as being polymerisable much faster than the current standard three to five siloxane unit ring oligomers, particularly octamethylcyclotetrasiloxane oligomers at the same reaction temperature but also can be prepared under milder conditions (i.e., at lower temperatures).

The above provides a number of advantages, firstly, the use of said macrocyclic cyclosiloxane oligomers as component (i) has the significant advantage that even with these milder reaction conditions (low reaction temperatures) both end-blockers (ii) and co-monomers (iii) are readily incorporated into the resulting polymer if desired. Indeed, it was identified that even with large amounts of co-monomer (iii) present, polymer could be readily made using macrocyclic cyclosiloxane oligomers as component (i) i.e., tetradecamethylcycloheptasiloxane. Secondly, if reaction conditions are maintained, more polymers can be prepared in existing polymerisation units and thirdly if milder conditions (lower temperatures) are relied upon such a process would render it easier to undertake subsequent processes especially stripping processes when used in step (h) of the process defined herein with e.g., a wiped film evaporator.

We found that even with large amounts of co-monomer (e.g., greater than 30 wt. %) present as a starting ingredient, polymer could be readily made using macrocyclic cyclosiloxane oligomer starting materials (i) having seven siloxane units (e.g., tetradecamethylcycloheptasiloxane). The use of said macrocyclic cyclosiloxane oligomers as feedstocks provides the added advantage of reduced small chain (3-5 siloxane units) cyclic by-products.

The polymers resulting from the polymerisation of macrocyclic cyclosiloxane oligomers as described herein may be utilised as the siloxane polymer ingredient in any composition utilising siloxane polymers. For example, a standard siloxane polymer used the preparation of liquid silicone rubber compositions or condensation cure sealants and adhesives may be replaced by equivalent siloxane polymer as made by the process described herein.

### EXAMPLES

These examples are intended to illustrate some embodiments of the disclosure and should not be interpreted as limiting the scope set forth in the claims.

The following ingredients are referred to in Table 1 in respect to examples Ex. 1 to 7 and Comparatives C.1 to 3.

### Cyclosiloxane Oligomers (Cyclics Dx)

D4 was octamethylcyclotetrasiloxane supplied 98% pure from MiliporeSigma of Burlington Massachusetts USA;
D5 was decamethyl-cyclopentasiloxane supplied 97% pure from MiliporeSigma of Burlington Massachusetts USA;
D6 was dodecamethyl-cyclohexasiloxane from Gelest Inc. of Morrisville, Pennsylvania USA;
D7 was tetradecamethyl-cycloheptasiloxane supplied 95% pure from Gelest Inc. of Morrisville, Pennsylvania USA.

### End-Blockers

HMDS was Hexamethyldisiloxane supplied 98% pure from MiliporeSigma of Burlington Massachusetts USA;
PDMS (20 cSt) was XIAMETER™ PMX-200 Silicone Fluid 20 cSt, a trimethyl terminated polydimethylsiloxane having a viscosity of 20 cSt at 25° C., commercially available from Dow Silicones Corporation of Midland, Michigan USA;
TMDS (Si—H) was 1,1,3,3-Tetramethyldisiloxane, (which has two Si—H bonds) supplied 97% pure from MiliporeSigma of Burlington Massachusetts USA;
DVTMDS (vinyl) was 1,3-Divinyltetramethyldisiloxane supplied 97% pure from MiliporeSigma of Burlington Massachusetts USA.

### Co-Monomers

D4′ (Si—H) was 2,4,6,8-Tetramethylcyclotetrasiloxane ([(CH₃)(H)SiO]₄), supplied 98.5% pure from MiliporeSigma of Burlington Massachusetts USA;
1107 (Si—H) was XIAMETER^{T}M MHX-1107 Fluid 30 cSt, a trimethyl terminated polymethylhydrogensiloxane polymer having a viscosity of 30 cSt at 25° C., commercially available from Dow Silicones Corporation of Midland, Michigan USA;
Hexenyl was a mixture of methylhexenyl-cyclosiloxane oligomers and silanol terminated methyl/hexenyl homopolymer with an average degree of polymerisation of 14.6.

### Catalysts

PFBSA was Nonafluorobutane-1-sulfonic acid supplied 97% pure from MiliporeSigma of Burlington Massachusetts USA;
Dowex™ DR-2030 Catalyst comprises styrenic plastic beads functionalized with sulfonic acid groups and are commercially available from The Dow Chemical Company of Midland, Michigan, USA.

All above parameter values and purity levels are taken from supplier data.

TABLE 1
Starting ingredients used for Examples
1 to 7 and comparative examples 1 to 3.

| | Cyclic Dx | End-blocker | Co-monomer | Catalyst |
|---|---|---|---|---|
| Ex. 1 | 7 | HMDS | None | PFBSA |
| Ex. 2 | 7 | PDMS (20 cSt) | None | Dowex ™ 2030 |
| Ex. 3 | 7 | HMDS | D4′ (Si—H) | PFBSA |
| Ex. 4 | 7 | HMDS | 1107 (Si—H) | Dowex ™ 2030 |
| Ex. 5 | 7 | TMDS (Si—H) | None | PFBSA |
| Ex. 6 | 7 | DVTMDS (Vi) | None | PFBSA |
| Ex. 7 | 7 | HMDS | Hexenyl | PFBSA |
| C. 1 | 4 | HMDS | None | PFBSA |
| C. 2 | 5 | HMDS | None | PFBSA |
| C. 3 | 6 | HMDS | None | PFBSA |

The “Cyclic Dx” column indicates the number of siloxane units in the starting cyclosiloxane monomer. Each of examples 1 to 7 and comparatives 1 to 3 followed the same polymerisation process with the obvious exception where no co-monomer was introduced into the composition. In order therefore to reduce repetitiveness, one example (Ex. 3) used when co-monomer was introduced, one example where no co-monomer was introduced (Ex. 6) and one comparative (C. 3) will be described. Small scale reactions were carried out in vials with a septum under a nitrogen atmosphere in a “pie plate” sample holder for a standard stir plate commercially available from IKA.

### Ex. 3

To a vial of 2 US fluid ounces (59.15 cm³) containing a stir bar and a cap with a septum was added 10 milliliters of tetradecamethylcycloheptasiloxane, 0.2 milliliters of D4′ (Si—H) co-monomer and 0.082 milliliters' of HMDS end-blocker. These were premixed, the vial sealed, and a nitrogen line placed through the septum. The vial was heated to 70° C. 5 μL of PFBSA was then added neat and the reaction proceeded for 2.5 hours. After the 2.5 hours the contents of the vial were neutralized with a 1.1 molar equivalent (relative to PFBSA) of pyridine (8 μL in the form of a 5 wt. % solution in dichloromethane). Full conversion was reached, with near equilibrium level of D4′ (Si—H) co-monomer cyclic ring-opening polymerisation (ROP) was completed before the tetradecamethylcycloheptasiloxane was consumed.

The non-volatile content (NVC) was 86.35% determined by NMR.

### Ex. 6

To a vial of 2 US fluid ounces (59.15 cm³) containing a stir bar and a cap with a septum was added 10 milliliters of tetradecamethylcycloheptasiloxane, and 0.082 milliliters of (DVTMDS) (Vi) end-blocker. These were premixed, the vial sealed, and a nitrogen line placed through the septum. The vial was heated to 70° C. 5 μL of PFBSA was then added neat and the reaction proceeded for 2.5 hours. After the 2.5 hours the contents of the vial were neutralized with a 1.1 molar equivalent (relative to PFBSA) of pyridine (8 μL in the form of a 5 wt. % solution in dichloromethane). Full conversion was reached.

### C.3

To a vial of 2 US fluid ounces (59.15 cm³) containing a stir bar and a cap with a septum The D6 was stirred after which the vial sealed, and a nitrogen line placed through the septum. The vial was heated to 70° C. 5 μL of PFBSA was then added neat and the reaction proceeded for 2.5 hours.

After the 2.5 hours the contents of the vial were neutralized with a 1.1 molar equivalent (relative to PFBSA) of pyridine (8 μL in the form of a 5 wt. % solution in dichloromethane). Only 65% of the D6 monomer was consumed.

The Mw and Mn results in Table 2 below were determined using size exclusion chromatography apart from Ex. 4 which was determined by way of nuclear magnetic resonance (NMR). The amount of cyclics remaining after completion of the ring opening polymerisation process was determined by means of NMR and in the case of Ex. 3 and Ex. 6 these were confirmed by volatiles analysis.

Further details on the test methods are discussed below:

### Size Exclusion Chromatography (SEC or GPC):

GPC samples were prepared as 2 mg/mL samples in toluene and were run on an Agilent^{tm} 1260 GPC with Mixed C or D columns and a refractive index detector. Samples were run with a toluene eluent at a flow rate of 1.00 mL/min at a temperature of 35° C.

### Nuclear Magnetic Resonance (NMR):

¹H and ²⁹Si NMR were taken on a Varian 400 MHz spectrometer with a Bruker SampleExpress autosampler and a cryoprobe. ²⁹Si NMR samples were prepared as solutions in CDCl₃ with ~10⁻² M Chromium (III) acetylacetonate (Cr(acac)₃) as a spin relaxation agent.

### Volatiles Analysis:

Volatiles analysis was conducted in a Mettler Toledo HB43 moisture analyzer by weighing out ~4 g of polymer and then heating the polymer to 200 C for 30 minutes and subsequently re-weighing the sample.

TABLE 2
Results after polymerisation of Ex. 1 to 7 and C. 1 to 3

| | Mn | Mw | PDI | % Cyclics ((NMR) |
|---|---|---|---|---|
| Ex. 1 | 29783 | 48549 | 1.6 | 12 |
| Ex. 2 | 22002 | 37543 | 1.7 | 13 |
| Ex. 3 | 44519 | 74148 | 1.7 | 15* |
| Ex. 4 | 3994 (NMR) | — | — | ND |
| Ex. 5 | 12049 | 18369 | 1.5 | 13 |
| Ex. 6 | 68893 | 111386 | 1.6 | 13** |
| Ex. 7 | 21458 | 34065 | 1.6 | 13 |
| C. 1 | 11555 | 21609 | 1.9 | 53 |
| C. 2 | 16721 | 26041 | 1.6 | 46 |
| C. 3 | 20786 | 32166 | 1.6 | 43 |

The volatiles analysis test was carried out of the polymerisation product of Ex. 3 and Ex. 6 and the result proved to be very similar. In the case of Ex. 3 the non volatiles content (NVC) of 86% and therefore a volatiles content of about 14 wt. % and for Ex. 6 the non-volatiles content (NVC) of 87 wt. % and therefore a volatiles content of about 13 wt. %

It can be seen that from the results in Tables 1 and 2 that the macrocyclic cyclosiloxane oligomers, specifically tetradecamethyl cycloheptasiloxane can be polymerized with a vinyl end-blocker (Ex.6), a methyl end-blocker (Ex.1 to 4 and 7) and an Si—H end-blocker (Ex.5). Furthermore, macrocyclic cyclosiloxane oligomers, specifically tetradecamethyl cycloheptasiloxane can be copolymerized with a cyclic co-monomer and can be polymerized/equilibrated with a second polymer (e.g., 1107 in Ex. 4). macrocyclic cyclosiloxane oligomers, specifically tetradecamethyl cycloheptasiloxane can also be polymerized with a hydrolysate (e.g., hexenyl in Ex. 7) and can additionally be polymerized with a heterogeneous catalyst (Ex. 2 and Ex. 4). Furthermore, when comparing Ex. 1 to 3 with comparatives C. to 3 that macrocyclic cyclosiloxane oligomers, specifically tetradecamethyl cycloheptasiloxane polymerization is faster than D4-6 when incorporating an end-blocker.

In Table 3, the residual cyclics profile is shown before and after stripping. The stripping process undertaken used a wiped film evaporator (WFE) at a temperature of 200° C. These results were analysed by way of gas chromatography as described below.

### Gas Chromatography (GC):

GC was taken on an Agilent™ 7890A with a DB5 column and a Gerstel MPS Sampling system. The method consisted of holding at 50° C. for 2 minutes, then ramping the temperature to 250° C. at 20° C. per minute and then holding the temperature at 250° C. for 3 minutes.

TABLE 3
A comparison of volatiles resulting from Ex.
6 before and after undergoing stripping.

| | % D4 | % D5 | % D6 | % D7 | % D8 | % D9 | % D10 |
|---|---|---|---|---|---|---|---|
| Ex. 6 | 44.7 | 28.03 | 12.13 | 6.21 | 1.35 | 0.87 | 0.69 |
| Ex. 6 | 5.22 | 11.32 | 15.24 | 9.63 | 5.99 | 4.46 | 3.74 |
| Stripped | | | | | | | |

The wt. % of volatiles in Table 3 does not add up to 100 wt. %, this is because the volatiles includes both cyclosiloxane oligomers having three siloxane units per ring and macrocyclic cyclosiloxane oligomer having 11 or more siloxane units per oligomer none of which were determined. This shows that by using cyclosiloxane oligomers having 7 to 10 siloxane units per ring as starting oligomers (i) the amount of residual siloxane rings having four siloxane units per ring by-products present are significantly reduced.

What is claimed is:

1. An acid catalysed process for the preparation of linear or branched siloxane polymers and copolymers, by the ring-opening polymerisation of macrocyclic cyclosiloxane oligomers having from 7 to 10 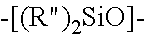
units per molecule, wherein each R″ group per unit is the same or different and is an alkyl group having from 1 to 6 carbons; which acid catalysed process comprises the steps of
(a) introducing
(i) said macrocyclic cyclosiloxane oligomers in an amount of from 20 to 99 wt. % of the starting ingredients with
(ii) one or more end-blockers in an amount of from 1 to 80 wt. % of the starting ingredients and optionally
(iii) a co-monomer selected from a linear organosiloxane co-monomer, a branched organosiloxane co-monomer or a cyclosiloxane co-monomer wherein said cyclosiloxane co-monomer has from 3 to 10 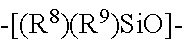
units per molecule, wherein each R⁸ group per is the same or different and is selected from an alkenyl group, an alkynyl group, an aryl group, a fluoroalkyl such as trifluoropropyl or a perfluoroalkyl group and each R⁹ group is selected from an alkyl group having from 1 to 6 carbons or R⁸; in an amount of from 1 to 80 wt. % of the starting ingredients into a mixing vessel and mixing;
(b) optionally introducing an organic solvent in an amount of up to 7.5 wt. % of the starting ingredients into the mixing vessel during or subsequent to step (a);
(c) heating said mixture of starting ingredients to a predetermined reaction temperature of from 25 to 160° C. in an inert atmosphere;
(d) once the predetermined reaction temperature has been reached, introducing a final starting ingredient, an acid catalyst (iv) selected from one or more sulphonic acids and/or perfluorinated sulfonic acids, one or more sulfonated polystyrene resins, one or more sulfonated tetrafluoroethylene bases fluoropolymer-copolymer resins or a mixture thereof;
(e) reacting the complete reaction mixture of step (d) at the predetermined reaction temperature for up to 24 hours until a step (e) product within a desired number average molecular weight range and/or a cyclics equilibration is obtained;
(f) quenching the reaction after step (e) by either filtering off heterogeneous acid catalysts when used or with a suitable neutralising agent to form a step (f) product;
(g) Cooling the step (f) product to ambient temperature to form a step (g) product and optionally,
(h) Stripping out remaining volatile materials from the step (g) product;
to give a final linear or branched siloxane polymer or copolymer.

2. The acid catalysed process for the preparation of linear or branched siloxane polymers and copolymers in accordance with claim 1 wherein the macrocyclic cyclosiloxane oligomers (i) comprise an oligomer consisting of seven —[(R″)₂SiO]— units per molecule, wherein each R″ group per unit is the same or different and is an alkyl group having from 1 to 6 carbons.

3. The acid catalysed process for the preparation of linear or branched siloxane polymers and copolymers in accordance with claim 1 wherein the macrocyclic cyclosiloxane oligomers (i) comprise one or more oligomers of the structure [(CH₃)₂)SiO]_{n″}, [(C₂H₅)₂)SiO]_{n″}, [(C₃H₇)₂)SiO]_{n″}, [(CH₃)(C₂H₅)SiO]_{n″} and/or [(CH₃)(C₃H₇)SiO]_{n″} where n″ is from 7 to 10.

4. The acid catalysed process for the preparation of linear or branched siloxane polymers and copolymers in accordance with claim 1, wherein the macrocyclic cyclosiloxane oligomers (i) comprise or consist of tetradecamethylcycloheptasiloxane, tetradecaethylcycloheptasiloxane, tetradecapropylcycloheptasiloxane, cyclohepta(methylethyl)siloxane, cyclohepta(methylpropyl)siloxane and mixtures thereof.

5. The acid catalysed process for the preparation of linear or branched siloxane polymers and copolymers in accordance with claim 1, wherein end-blockers (ii) comprise one or more dimethylalkenyl-terminated polydimethylsiloxanes having a degree of polymerisation of from 10 to 350, trialkyl-terminated polydimethylsiloxanes and one or more disiloxanes.

6. The acid catalysed process for the preparation of linear or branched siloxane polymers and copolymers in accordance with claim 1, wherein the end-blocker (ii) is selected from dimethyl vinyl-terminated polydimethylsiloxanes having a degree of polymerisation of from 10 to 100, dimethylhexenyl-terminated polydimethylsiloxanes having a degree of polymerisation of from 100 to 350, trimethyl-terminated polydimethylsiloxanes having a viscosity of from 15 to 200 mPa·s at 25° C., hexamethyldisiloxane, 1,1,3,3-tetramethyldisiloxane, and 1,3-divinyltetramethyldisiloxane.

7. The acid catalysed process for the preparation of linear or branched siloxane polymers and copolymers in accordance with claim 1, wherein co-monomer (iii) comprises or consists of a cyclosiloxane co-monomer having from 3 to 10 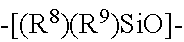
units per molecule, wherein each R⁸ group per is the same or different and is selected from an alkenyl group, an alkynyl group, an aryl group, a fluoroalkyl such as trifluoropropyl or a perfluoroalkyl group and each R⁹ group is selected from an alkyl group having from 1 to 6 carbons or R⁸ or a hydrolysate which is a mixture of cyclosiloxane and silanol-terminated homopolymer produced from the hydrolysis of a chlorosilane.

8. The acid catalysed process for the preparation of linear or branched siloxane polymers and copolymers in accordance with claim 1, wherein co-monomer (iii) comprises or consists of a trialkyl silyl-terminated linear or branched organopolysiloxane comprising units of the structure 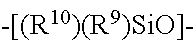
units per molecule, wherein each R¹⁰ group per is the same or different and is selected from an alkenyl group, an alkynyl group, an aryl group, a fluoroalkyl such as trifluoropropyl or a perfluoroalkyl group or a primary or secondary amine groups or alkylethylenediamine groups and each R⁹ group is selected from an alkyl group having from 1 to 6 carbons or R¹⁰.

9. The acid catalysed process for the preparation of linear or branched siloxane polymers and copolymers in accordance with claim 1, wherein the organic solvent is present in an amount of up to 30 wt. % of the starting ingredients and is added into the mixing vessel during or subsequent to step (a).

10. The acid catalysed process for the preparation of linear or branched siloxane polymers and copolymers in accordance with claim 9 wherein the organic solvent concerned is a linear, branched or cyclic aliphatic hydrocarbon, which in each case is optionally chlorinated; a linear, branched or cyclic ether or an aromatic solvent.

11. The acid catalysed process for the preparation of linear or branched siloxane polymers and copolymers in accordance with claim 1, wherein in step (c) the mixture of starting ingredients is heated to a predetermined reaction temperature of from 25 to 100° C. in an inert atmosphere.

12. The acid catalysed process for the preparation of linear or branched siloxane polymers and copolymers in accordance with claim 1, wherein the catalyst is an acid catalyst selected from one or more of a perfluorinated sulfonic acids, a perfluorobutane sulfonic acid, one or more sulfonated polystyrene resins, one or more sulfonated tetrafluoroethylene bases fluoropolymer or a mixture thereof.

13. The acid catalysed process for the preparation of linear or branched siloxane polymers and copolymers in accordance with claim 1, wherein no organic solvent is introduced into the mixing vessel during or subsequent to step (a).

14-16. (canceled)
